(19) United States
(12) Patent Application Publication
(10) Pub. No.: US 2002/0145617 A1
(43) Pub. Date: Oct. 10, 2002

(54) Methods of marketing maps depicting the location of real property and geographic characteristics in the vicinity thereof

(76) Inventors: Robert M. Kennard, Dallas, TX (US); John W. Howard, North Richland Hills, TX (US)

Correspondence Address: Robert C. Klinger, Jackson Walker LLP, Suite 600, 2435 North Central Expressway, Richardson, TX, 75080, US

(21) Appl. No.: 10/118,507

(22) Filed: Apr. 8, 2002

Related U.S. Application Data
(60) Provisional application No. 60/282,041, filed on Apr. 6, 2001.
(60) Provisional application No. 60/282,815, filed on Apr. 10, 2001.
(60) Provisional application No. 60/294,731, filed on May 31, 2001.

(51) Int. Cl. G06F 17/60; G09G 5/00

(52) U.S. Cl. 345/634; 705/1

(57) ABSTRACT

A computer-implemented method permits a service provider to provide to a customer a map that accurately depicts a selected trait present at the site of and in the vicinity of selected real property. The trait may relate to flooding characteristics, air quality, median income, average home value, or other qualities at and near the site, and the map may emanate from, and be subject to change by, an issuing entity, such as FEMA, EPA, a multiple listing service, a bank or other such entity. The service provider electronically obtains the location of the site on a georeferenced street or similar first map. By electronically relating the first map to a second georeferenced map that depicts the trait, the site is located on the second map, which may thereafter be electronically stored and furnished to the customer, along with certain information regarding the trait or other matters, such as advertising or demographics. Following a change to the second map, the service provider georeferences the changed map, electronically locates the site thereon, and furnishes same to the customer along with information such as that informing of the consequences of the change or other matters.

### CROSS REFERENCE TO RELATED APPLICATIONS

The disclosure of the present invention is based on and claims priority from the following commonly assigned provisional application: Serial No. 60/282,041, filed Apr. 6, 2001. Moreover, the disclosure of the present invention is related to and/or provides a business and marketing platform for the inventions disclosed in the following commonly assigned, co-pending patent applications: Provisional, Serial No. 60/282,815, filed Apr. 10, 2001; provisional, Serial No. 60/294,731, filed May 31, 2001; provisional, Serial No. ______ [Docket 108344.00002], filed Jan. 17, 2002; provisional, Serial No. ______ [Docket 108344.00005], filed Jan. 17, 2002; Ser. No. 09/537,162, filed Mar. 29, 2000 (the “'862 application”); Ser. No. 09/537,849, filed Mar. 29, 2000 (the “'849 application”); and Ser. No. 09/537,161, filed Mar. 29, 2000 (the “'161 application”). All of the foregoing are incorporated by reference hereinto.

### FIELD OF THE INVENTION

The present invention generally relates to methods of marketing maps that depict the location of real property as well as certain geographic characteristics in the vicinity of the property. More specifically, the present invention relates to business methods for providing to customers maps that depict selected real property as well as the flood zone classification or other geographic characteristic at the site of and in the vicinity of the real property.

### BACKGROUND OF THE INVENTION

The above-noted '849 application discloses and claims a system and method for georeferencing one or more originally non-georeferenced maps, such as a FEMA flood maps or other maps intended to inform of the condition of the land at and in the vicinity of a piece of real property. Typically, the non-georeferenced maps are paper maps. The system and method contemplate first securing and storing in the system a georeferenced map, such as a vector map, containing the geographic area covered by the non-georeferenced map or maps, and then scanning each paper map to produce a raster image thereof which is also stored in the system. Like the paper map from whence it came, the raster map is non-georeferenced, having an internal reference system of x,y Cartesian coordinates, each of which denotes the position of a pixel of the raster image.

Each raster image is then generally simultaneously displayed along with the portion of the vector map that contains the area covered by the displayed raster image. Since the vector map is typically a road-map-type of map and the raster image is primarily intended to show the condition of land, e.g., its flood zone classification, the visual impact of each is quite different. Nevertheless, both images will usually contain common artifacts, such as streets, stream beds, railroad tracks, intersections of and among the foregoing, mountain peaks, buildings, shoreline, and the like.

A system user manipulates both images until each display covers approximately the same geographic area. The user than “marks” as points those artifacts shown in common in both images. For example, if both images depict the intersection of the same two streets, the user marks the intersections by “clicking” a mouse on the intersection in both images to establish a “point-pair.” A stored algorithm calculates a function f which relates the x,y coordinates of the intersection on the raster image to the latitude and longitude of the intersection on the vector image, that is f(x,y)=lat,lon. The inverse function g establishes the reverse relationship, i.e., g(lat,lon)=(x,y).

A second point-pair is then marked at another common artifact. The algorithm now calculates the functions f and g, thereby providing an initial georeferencing function set by which the two images may be related. As additional point-pairs are marked, the georeferencing functions are refined, until they accurately geographically relate the raster and vector images. The final georeferencing functions are stored. Accordingly, whenever the raster image is displayed, modified, manipulated or otherwise operated on, these operations may be performed pursuant to geographic coordinates of latitude and longitude. The raster image of the non-georeferenced scanned paper map is now georeferenced.

The above-noted '162 application covers a system and method for synchronizing the displayed images of two maps, such as the initially non-georeferenced raster image of the paper map and the georeferenced vector map image. Synchronization is achieved as the algorithm calculates the georeferencing functions. Once the functions are established, manipulation of either image—such as scrolling, panning, zooming in or out, or rotating—causes the same manipulation to be applied to the other image. This synchronization is helpful, inter alia, when the user is attempting to locate and mark common artifacts on the two images.

The above-noted '161 application relates to a system and method for performing assessments of the geographic characteristics of land at and near the location of a piece of real property. Specifically, the '161 application relates to a system and method for performing flood zone certifications.

After FEMA flood maps are georeferenced by the systems and methods of the '849 and '162 applications, similar segments of the vector map each have “attached” thereto all georeferenced flood map images that intersect the segment. As a result, if a property is locatable within one of the segments when its address is given, only the attached flood map images need to be examined to determine which one is usable to determine flood zone classification. Often, there will be only one flood map attached to a vector map segment, in which event, no human intervention is needed to determine the applicable flood map. If two or more flood maps are so attached, human intervention can determine which one is the proper flood map.

In view of the foregoing, the present invention relates to methods of commercializing and marketing the evaluations of the geographic quality of the land at and near a selected piece of real property.

### SUMMARY OF THE DISCLOSURE

With the above in view, a first aspect of the present invention contemplates a computer-implemented method by which a service provider can generate for a customer a map that accurately depicts a selected geographic characteristic or quality at the site of selected real property and in the property's vicinity.

According to this first aspect, either the customer is digitally furnished with a first georeferenced map or the customer furnishes the service provider with an address of property of interest. Either may occur because of a request initiated by the customer in response to advertising by the service provider or word of mouth from the provider's satisfied customers. On the other hand, the customer may request a first map in response to the service provider's electronically, or otherwise, contacting the customer.

If a first map is furnished it bears indicia indicating the purported site of the property and is accompanied by instructions. The instructions inform that if, and only if, the purported site is incorrect, the customer should move or correct the indicia so that the correct site is indicated, and, thereafter, return the first map to the service provider. After the map showing the correct site is received by the service provider, such correct site is located on a second georeferenced map. The second map depicts the selected characteristic, which, in some embodiments, is a flood zone classification. Locating the correct site on the second map is achieved by relating the maps to each other.

The second map is then marked to indicate the property's site. Last, a selected portion—some or all—of the second map is digitally provided to the customer with the correct site of the property shown thereon.

As noted, the customer may be invited to provide an address for the property. When the address is provided, it is used by the service provider to locate the property on the first map. Thereafter, the site is located on the second map.

In another variant, the site is located on two or more second maps. In this event, the site is delineated on all involved second maps, all of which are provided to the customer, who is requested to indicate which of the second maps best depicts both the site of the property and the geographic characteristic of interest. In yet another variant, the customer is permitted to download the portion of the second map, which may be accompanied by other information, such as a scale legend, a compass rose, advertising, demographic data and the like. The customer may be permitted to download the second map portion and the other information to a suitable memory medium or to a printer.

In yet another variant of the first aspect, the invention is the portion of the second map produced by the foregoing methods and provided to the customer in any manner, whether or not the customer subsequently downloads the map. In a still further variant of this first aspect, the invention is a storage medium or device which contains software capable of operating a general purpose computer to effect any of the variant methods described above.

In a second aspect, the present invention contemplates a method similar to the foregoing, except that the first georeferenced furnished to the customer bears no indication of the purported site of the property. After electronically receiving the first map, the customer electronically marks the site of the property thereon and electronically returns the first map to the service provider. The first map may be in digital form stored on a medium, the storage medium being furnished to the customer to effect furnishing the first map. In this latter event, the storage medium may also contain tools usable by the customer to indicate the site of the property on the first map and to thereafter transmit the first map back to the service provider. In a variant of this second aspect, the second map portion may be provided to the customer either by direct transmission or by giving the customer a storage medium containing the second map in digital form. In either of the latter events the second map portion may be accompanied by other information, as described earlier, and both may be suitable for rendering by the customer in tangible form. In additional variants, (i) the first map is a digital version of an original paper map, (ii) before the second map portion is provided to the customer, it is assigned a selected scale, which may be indicated on an included scale legend, and is rotated so that North is in a selected orientation.

In a third aspect, the present invention contemplates that the second map is a scanned or raster version of a paper map, the latter being a FEMA flood map. Where the second map is issued by an authorized entity, such as FEMA, it is typically subject to being changed by the entity. Accordingly, the service provider may, in response to such a change to the second map—actually a change to the paper version of the second map—georeference the changed second map, preferably, but not necessarily, via the method of the '849 application. The site of the property is then located on the georeferenced changed second map, using the first map previously manipulated to show the site of the property, and this site is delineated thereon. The service provider then provides the changed second map to the customer along with other information. The other information may textually inform the customer of the significance of the change to the second map. The foregoing may be marketed on a subscription basis to various customers, who are thereby informed, in specific embodiments, of changes in the flood zone classification of the land on which their property resides and any related changes regarding flood insurance.

### DETAILED DESCRIPTION

As described earlier, the present invention rests on the inventions of the '849, '161 and '162 applications, which permit non-georeferenced paper maps to be converted to a georeferenced raster format via the use of a companion vector map. In specific embodiments, the paper maps are FEMA flood maps which are used to provide to property owners, lending institutions and others flood zone classifications or certificates, with reference to which the acquisition or dropping of flood insurance may be effected.

It is to be understood that while specific embodiments deal with flood zone classifications, the present invention contemplates methods of furnishing maps showing both the site of selected property—either as a “point” on a map or as an area bounded by a polygon—and various characteristics extant at and in the vicinity of the property. The characteristics which may be shown on the maps include geographic characteristics, such as flood zone status, soil type and quality, subsurface water; ecological characteristics, such as air quality, water quality, pollen and fungus concentrations; climatological characteristics, such as amount of rainfall, average temperature, likelihood of tornadoes; demographic characteristics, such as average income or home cost, population density; and any other characteristic that can be shown on a map by coloration, shading (as in the case of FEMA flood maps) or other indicia, along with the location of the selected property.

Turning to the contemplated specific embodiments, over 100,000 FEMA flood maps exist; the majority of them are not georeferenced. The above-noted '849, '161 and '162 applications result in such georeferencing so that originally non-georeferenced raster images of the FEMA maps are mathematically related to a georeferenced map, such as a vector map. As a consequence, any point identified on the vector map may be simultaneously identified on the raster map. If the vector map is a street map, a property address may expeditiously be located thereon. Because of the established mathematical relationship between the vector map and the scanned raster map, the property may be expeditiously located on the raster map. If, as in the specific embodiments hereof, the raster map is an image of a FEMA flood map, the flood zone status of the property may be just as expeditiously determined.

In the following examples of marketing and commercializing a map delineating both the location of a property and a characteristic or quality extant at and in the vicinity of that property, certain of the steps taken are preferably computer-implemented and are electronically and/or digitally performed.

### EXAMPLE 1

This example relates to a customer obtaining from a service provider a product related to the contents of a related FEMA flood map. The customer, who has previously learned of the service provider, gains access to the Internet and clicks on an appropriate link. This gives the customer access to a form at the provider's web site. The form requests that the customer fill in the address of certain property for which, in this example, the georeferenced portion of a FEMA Flood Insurance Rate Map (“FIRM”) is desired. Typically, the address is a street address or mailing address, but may be in the form of latitude/longitude, metes-and-bounds, a legal description, address or some other location identifier or address for the property.

In response to electronically submitting the completed form, a georeferenced street map, such as that available via Mapquest, is displayed. On the map, a star or other icon marks the purported site of the property. If the icon's location is correct, the customer essentially submits the latitude and longitude for the subject property to the provider. If the icon's location is incorrect, the customer may, using a computer mouse or similar device, relocate the subject property to its correct physical location on the digital street map. In either event, the provider electronically receives a latitude and longitude for the site of the property correctly identified.

Back at the service provider's facility, the latitude and longitude of the property are matched to a list of possible georeferenced FEMA flood maps and the list is returned to the user. The user then selects from the list one or more FIRMs that apply to the subject location At times, the site may be included on two or more FEMA maps. In this event, the FEMA maps containing the subject property are all sent to the customer, who is instructed to select the one or more FEMA maps available for providing FEMA flood map-related information, including that contained in aFloodscape™ product for the property and to identify it by clicking on an appropriate icon.

The customer may save the flood map incorporating the subject property in a digital form on a hard disk or other memory of the computer system, on a floppy disk, on a CD or on hard copy produced by a printer by clicking on the proper icon.

### EXAMPLE 2

This is similar to Example 1, except that instead of being invited to provide an address, the customer is electronically presented on a computer system with a display of a georeferenced street map. The customer is asked to identify the location of the property on the street map by appropriately clicking a mouse or a functionally similar device. Once the property's site has been so marked, the customer electronically transmits the marked map to the service provider, and the remainder of the method may proceed as described above.

### EXAMPLE 3

As in Examples 1 and 2, the customer ultimately receives a flood map, or a map presenting some other geographic or ecological, or climatological characteristic of property and its environs with the site of the property indicated. The location of the property need not necessarily be a “point” on the displayed map image. The site of the property may also constitute an area surrounded by a polygonal boundary. The polygon may be electronically drawn by the customer by virtue of the service provider having electronically furnished annotation tools along with the street map.

### EXAMPLE 4

As in Examples 1, 2 and 3, however instead of receiving an entire FEMA flood map, the customer electronically receives a the relevant portion of a flood map, i.e., a portion of the proper FEMA Flood Insurance Rate Map (“FIRM”) or Flood Hazard Boundary Map (“FHBM”), together or both of which are referred to as “flood map” with the property's site indicated thereon, known as a Floodscape™. The property site may be more or less centrally located on the map portion. The scale of the map may be selectively different—either smaller or larger—than the scale of the paper FEMA map from which the raster map was made and may be selected to permit the customer to print the map on paper of a common size, e.g., 8½″ by 11″ or A4. The map portion provided to the customer may also be rotated by the service provider from its orientation on the original FEMA paper map, which may be desirable where the original FEMA map did not have North directed “upwardly.”

Other information may be added to or may accompany the FEMA map. Property markers and boundary lines not present on the original FEMA paper map may be added to the map, as may a compass direction marker or compass rose and a scale legend. Other information may accompany the electronically furnished FEMA map in margins provided around the map by selection of an appropriate scale therefrom. Such information may include a variety of textual material, whether or not it is provided on the original paper flood map or its raster image. This textual material may includes such information as the flood map panel number or suffix, community names, map revision dates. The name and address of the service provider, and/or the name of an entity that issues flood insurance.

### EXAMPLE 5

This Example is similar to any of Examples 1-4, but early contact between the customer and the service provider includes the service provider agreeing to furnish the customer with a memory medium (diskette, CD-ROM), firmware, or a device from which the customer can download and display on a computer display either the georeferenced street map or the address form of earlier examples. In either event, the medium or device also may include appropriate tools for annotating or completing the map or form and transmitting them to the service provider, who thereafter furnishes the FIRM, a Floodscape™, a flood hazard determination, an insurance quote, a mortgage quote, a FloodZAP, a PMI Alert, and/or other product applicable to the subject property.

### EXAMPLE 6

In this Example, the service provider places the customer in the position of providing maps, Floodscapes™, flood hazard determinations, insurance quotes, mortgage quote, a FloodZAP, a PMI Alert, and/or other products showing the sites of properties of interest along with certain geographic, climatological, ecological or demographic characteristics, such as the flood zone status of the sites and the surrounding areas, the quality of the air at and around the properties' sites, the likelihood of an earthquake occurring at or near a property's site, and other such information. Here the service provider furnishes the customer with the software (and possibly hardware) necessary to cause a general purpose computer to perform the methods described above. The software may be resident on a storage media, such as a disk, diskette or CD-ROM, or it may be resident on a server or the like. Indeed, the latter manner of furnishing the software is especially expedient where the customer intends to provide maps depicting property and geographic conditions over a large area, such as the 100,000+ FEMA maps covering the entire US.

### EXAMPLE 7

Here, the service provider utilizes information concerning mortgages, houses for sale, recent contracts of real estate sale where closing have/have not yet occurred, etc., to develop a database of property owners who might have an interest in learning about flood zones and/or flood zone insurance. Having retrieved the address of each property in question, the service provider develops a flood zone map indicating the location of each property. On each flood zone map or adjacent thereto, for example in a margin or border surrounding the map as displayed or printed, the service provider appends additional information such as an indication of how far the property is from a flood zone, premiums ranges for an appropriate level of flood insurance, or other marketing/sales information relating to a product or service tied to flood zone statue and/or insurance.

### EXAMPLE 8

In this Example, denoted a “flood zone alert plan” (or “FloodZAP”); the service provider and the customer enter into an agreement pursuant to which the service provider agrees to send the customer updated maps when such are required. In the case of FEMA flood maps, this would occur if and when FEMA amends or changes a flood map due to altered conditions of the area depicted thereon. These changes are effected by FEMA via flood insurance rate maps (“FIRM”), Letters of Map Amendment (“LOMA”), Letters of Map Revision (“LOMR”), and/or Letters of Map Change (“LOMC”). If, after the service provider has previously identified the property of interest, a revised FIRM/LOMA/LOMR/LOMC is issued, and those changes materially effect the subject property, a new Floodscape™ and applicable informative information (FloodZAP™) is then sent to the customer, electronically or on a memory medium/device, as described in earlier Examples. In addition to the revised Floodscape™, the consumer will receive a letter telling them the effects of the flood status change and the action they should take to conform to that change. For example, if they For example, a property that was not previously located in a special flood hazard area (“SFHA”) may now be located therein. If so, and if that community participates in the National Flood Insurance Program (“NFIP”), it may be necessary for some entity, such as the lender or servicer, to acquire flood insurance on behalf of the consumer. The name and address of one or more flood insurance providers may be provided, as may premium rate schedules. Similarly, if a property is “moved out” of a SFHA, the need for flood insurance may be decreased or eliminated.

The foregoing is important when the customer is a homeowner. In general, the National Flood Insurance Reform Act of 1994 requires federally regulated lenders (all national banks, all federal credit unions, and all mortgage companies that sell to Fannie Mae/Ginnie Mae) to perform a flood hazard determination each time they “make, extend, renew, or increase” a loan on a real property that is secured by a structure or mobile home in excess of $1,000 in value. The purpose of the act is to ensure that lenders determine whether or not any improvements are located in a special flood hazard area (SFHA). In addition, the lender must track a property during the “term of the loan” to ascertain whether there are any changes in the flood zone status of the improvements after the date of any of the foregoing trigger events.

If the property's flood zone status changes to that the borrower is now located in a SFHA, the foregoing lenders must require the owner to purchase flood insurance. If the property owner refuses to do so, then the lender must “force place” the flood insurance for the borrower. However, if the subject property is no longer located in a SFHA, the lender may not alert the owner that flood insurance is no longer needed. Pursuant to this embodiment, the homeowner can take advantage of lowered or eliminated need for flood insurance.

While the invention has been described and exemplified with reference to various embodiments, it will be understood by those skilled in the art that various changes in form and detail may be made herein without departing from the spirit and scope of the invention as set forth in the following claims.

What is claimed is:

1 A computer-implemented method by which a service provider furnishes to a customer a map which depicts a selected geographic characteristic or quality at the site of, and in the vicinity of, a selected property, which method comprises:
electronically obtaining from the customer sufficient information to permit the service provider to identify the location of the site of the property on a georeferenced digital map;
thereafter, electronically locating the site of the property on the georeferenced digital map, which depicts the selected characteristic or quality, the georeferenced map emanating from an issuing entity and being subject to updating by that entity;
electronically delineating the site of the property on the second map; and
electronically storing a selected portion of the second map, with the site delineated on that portion.

2. A method as in claim 1, which further comprises:
following the entity making an alteration to the georeferenced map,
electronically georeferencing the altered map,
electronically locating the site of the property on the altered map,
electronically delineating the site of the property on the changed map; and
electronically providing to the customer a selected portion of the changed map, with the site delineated on that portion, along with other selected information.

3. A method as in claim 2, wherein:
the delineated site is generally centrally located on the portion of the changed georeferenced map.

4. The selected portion of the changed georeferenced map produced by the method of claim 2.

5. A product which includes the selected portion of the changed georeferenced map produced by the method of claim 2, wherein the selected information comprises one or more of:
annotations and text from other georeferenced maps, a compass rose denoting North,, other designations found on the original and second maps, a scale legend, advertising/marketing/sales information, demographic data related to the general area of the delineated site, other legends and other information, the included ones of the foregoing being present on, surrounding, or accompanying the selected portion of the second map.

6. A product produced by the method of claim 2, wherein:
the selected geographic characteristic or quality comprises the flood zone designations at and in the vicinity of the site of the selected property, and
the second maps are FEMA flood maps.

7. A computer-implemented method by which a service provider furnishes to a customer a map which depicts a selected trait at the site of, and in the vicinity of, selected property, which comprises:
electronically furnishing the customer with facilities and instructions for the use thereof so that the customer can electronically enable the service provider to electronically locate the site of the property on a first georeferenced map;
thereafter, electronically locating the indicated site on a second georeferenced map depicting the selected trait by electronically relating the two maps to each other;
electronically delineating the site of the property on the second map; and
electronically storing and providing to the customer a selected portion of the second map with the site delineated thereon, the map portion being accompanied by other selected information.

8. A method as in claim 7, wherein:
the second map emanates from an issuing entity and is subject to being altered by that entity, which method also further comprises
after a change is made to the second map by the entity,
electronically georeferencing the changed second map,
electronically delineating the site on the georeferenced changed second map by electronically relating the first map and the changed second map to each other, and
electronically providing to the customer a selected portion of the changed second map, with the site delineated on that portion, along with other selected information.

9. A method as in claim 8, wherein:
the trait comprises the flood zone classifications at the site and in the vicinity thereof.

10. A method as in claim 9, wherein:
the selected information includes information to the customer concerning the customer's acquiring, altering or terminating flood insurance in the light of the flood zone classifications depicted on the changed second map.

11. A method as in claim 9, wherein:
the selected information includes information to the customer concerning the customer's altering any mortgage covering the property in the light of the flood zone classifications depicted on the changed second map.

12. The selected portion of the changed second map produced by the method of claim 8.

13. A product which includes the selected portion of the changed second map produced by the method of claim 8, wherein the selected information comprises one or more of:
annotationsor text present on other georeferenced maps, a compass rose denoting North, other designations found on the original and second maps, a scale legend, advertising, demographic data related to the general area of the delineated site, other legends and other information, the included ones of the foregoing being present on, surrounding, or accompanying the selected portion of the second map.

14. A product produced by the method of claim 8, wherein:
the selected geographic characteristic or quality comprises the flood zone designations at and in the vicinity of the site of the selected property, and
the second maps are FEMA flood maps.

15. The selected portion of the changed second map produced by the method of claim 10.

16. A product which includes the selected portion of the changed second map produced by the method of claim 10, wherein the selected information comprises one or more of:
annotations or test from other georeferenced maps, a compass rose denoting North, t other designations found on the original and second maps, a scale legend, advertising/marketing/sales information, demographic data related to the general area of the delineated site, other legends and other information, the included ones of the foregoing being present on, surrounding, or accompanying the selected portion of the second map.

17. A product produced by the method of claim 10, wherein:
the selected geographic characteristic or quality comprises the flood zone designations at and in the vicinity of the site of the selected property, and
the second maps are FEMA flood maps.

18. The selected portion of the changed second map produced by the method of claim 11.

19. A product which includes the selected portion of the changed second map produced by the method of claim 11, wherein the selected information comprises one or more of:
annotations or text from other georeferenced maps, a compass rose denoting North, to, other designations found on the original and second maps, a scale legend, the consequences of the change to the second map, advertising/marketing/sales information, demographic data related to the general area of the delineated site, other legends and other information, the included ones of the foregoing being present on, surrounding, or accompanying the selected portion of the second map.

20. A product produced by the method of claim 11, wherein:
the selected geographic characteristic or quality comprises the flood zone designations at and in the vicinity of the site of the selected property, and
the second maps are FEMA flood maps.
